(19) United States
(12) Patent Application Publication
(10) Pub. No.: US 2024/0048819 A1
(43) Pub. Date: Feb. 8, 2024

(54) METHOD FOR EDITING MATERIALS AND TERMINAL

(71) Applicant: BEIJING DAJIA INTERNET INFORMATION TECHNOLOGY CO., LTD., Beijing (CN)

(72) Inventor: Jiahui HONG, Beijing (CN)

(21) Appl. No.: 18/366,960

(22) Filed: Aug. 8, 2023

(30) Foreign Application Priority Data
Aug. 8, 2022 (CN) 202210944829.1

(51) Int. Cl. H04N 21/81; G06F 3/04842

(52) U.S. Cl. CPC H04N 21/8173; H04N 21/816; G06F 3/04842

(57) ABSTRACT

Provided is a method for editing materials to synthesize a video on a terminal. The method includes: displaying at least one first track in an editing interface, wherein each of the at least one first track includes at least one material; selecting a plurality of materials in a first region in response to a set operation on the first region in the editing interface, wherein the first region is configured to display materials for selection; and bulk-editing the selected plurality of materials.

### CROSS-REFERENCE TO RELATED APPLICATION

This application is based on and claims priority to Chinese Patent Application No. 202210944829.1, filed on Aug. 8, 2022, the disclosure of which is herein incorporated by reference in its entirety.

### TECHNICAL FIELD

The present disclosure relates to the field of computer technologies, and in particular, relates to a method for editing materials and a terminal.

### BACKGROUND OF THE INVENTION

With the rapid development of computer technologies, videos have become an important medium of user interaction. To improve playback of the videos, users may add a plurality of materials (for example, a video material, an audio material, a specific effect material, a subtitle material, and the like) to a video editing tool, and synthesize the videos based on the plurality of materials.

### SUMMARY OF THE INVENTION

Embodiments of the present disclosure provide a method for editing materials and a terminal.

In one aspect of the embodiments of the present disclosure, a method for editing materials is provided. The method includes:
displaying at least one first track in an editing interface, wherein each of the at least one first track includes at least one material;
selecting a plurality of materials in a first region in response to a set operation on the first region in the editing interface, wherein the first region is configured to display materials for selection; and
bulk-editing the selected plurality of materials.

In some embodiments, said selecting the plurality of materials in the first region in response to the set operation on the first region in the editing interface includes:
displaying the first region in the editing interface in response to a trigger operation on a display option for the first region in the editing interface, wherein an initial size of the first region is a predetermined size; and
selecting the plurality of materials in the first region.

In some embodiments, said displaying the first region in the editing interface in response to the trigger operation on the display option for the first region in the editing interface includes:
determining a track cursor in the editing interface in response to the trigger operation on the display option for the first region; and
displaying a first region including the track cursor in the editing interface.

In some embodiments, said displaying the first region including the track cursor in the editing interface includes:
acquiring a first time point corresponding to the track cursor;
acquiring a second time point by advancing the first time point by a first duration;
acquiring a third time point by delaying the first time point by a second duration; and
displaying a first region corresponding to a first time period in the editing interface, wherein the second time point is a start time point of the first time period, and the third time point is an end time point of the first time period.

In some embodiments, said displaying the first region including the track cursor in the editing interface includes:
acquiring any two coordinate points in the track cursor;
acquiring a plurality of coordinate points by translating each of the any two coordinate points leftwards and rightwards; and
displaying the first region in the editing interface based on the plurality of coordinate points, wherein the plurality of coordinate points are vertexes of the first region.

In some embodiments, said displaying the first region in the editing interface in response to the trigger operation on the display option for the first region in the editing interface includes:
acquiring a fourth time point and a fifth time point in response to the trigger operation on the display option for the first region, wherein the fourth time point is a start time point of the editing interface, and the fifth time point is an end time point of the editing interface; and
displaying a first region corresponding to a second time period in the editing interface, wherein the second time period is a time period between the fourth time point and the fifth time point.

In some embodiments, the method further includes:
adjusting the first region in response to an adjust operation on the first region, wherein the adjust operation is configured to adjust at least one of a position and a size of the first region.

In some embodiments, the method further includes:
displaying a second region in the editing interface in response to a trigger operation on a display option for the second region in the editing interface, wherein the second region is configured to display materials for deselection; and
deselecting materials in the second region.

In some embodiments, said deselecting the materials in the second region includes:
deselecting materials completely in the second region; or
deselecting materials at least partially in the second region.

In some embodiments, said selecting the plurality of materials in the first region in response to the set operation on the first region in the editing interface includes:
displaying the first region in the editing interface according to a swipe path of a swipe operation in response to the swipe operation in the editing interface; and
selecting the plurality of materials in the first region.

In some embodiments, said displaying the first region in the editing interface according to the swipe path of the swipe operation in response to the swipe operation in the editing interface includes:
displaying the first region according to a start point and a release point of the swipe path in response to the swipe operation, wherein the first region is a matrix with the start point and the release point being diagonal points, or a circle with a connecting line between the start point and the release point being a diameter; or
displaying the first region formed by the swipe path in response to the swipe operation, wherein the first region is an enclosed region formed by the swipe path.

In some embodiments, said selecting the plurality of materials in the first region includes:
selecting a plurality of materials completely in the first region; or
selecting a plurality of materials at least partially in the first region.

In some embodiments, said selecting the plurality of materials completely in the first region includes:
selecting the plurality of materials completely in the first region in response to a trigger operation on a cover selection option in the editing interface; and
said selecting the plurality of materials at least partially in the first region includes:
selecting the plurality of materials at least partially in the first region in response to a trigger operation on a cross selection option in the editing interface.

In some embodiments, the method further includes:
selecting materials in a target track in response to a select operation on the target track in the at least one first track.

In some embodiments, the method further includes:
deselecting any one of the selected plurality of materials in response to a deselect operation on the any one of the selected plurality of materials.

In some embodiments, the first track is a sub-track of a second track, and at least one second track is displayed in the editing interface; and said displaying at least one first track in the editing interface includes:
displaying the at least one first track of the second track in the editing interface in response to a trigger operation on any of the at least one second track, wherein the at least one material in the at least one first track belongs to a material type corresponding to the second track.

In some embodiments, the method further includes:
selecting history materials in response to a trigger operation on a history selection option in the editing interface, wherein the history materials include a plurality of materials selected at a previous time.

In some embodiments, said bulk-editing the selected plurality of materials includes:
displaying an editing option available to the plurality of materials in the editing interface; and
bulk-editing the selected plurality of materials in response to a trigger operation on any displayed editing option.

In another aspect of the embodiments of the present disclosure, an apparatus for editing materials is provided. The apparatus includes:
a displaying unit, configured to display at least one first track in an editing interface, wherein each of the at least one first track includes at least one material;
a selecting unit, configured to select a plurality of materials in a first region in response to a set operation on the first region in the editing interface, wherein the first region is configured to display materials for selection; and
an editing unit, configured to bulk-edit the selected plurality of materials.

In some embodiments, the selecting unit includes:
a displaying sub-unit, configured to display the first region in the editing interface in response to a trigger operation on a display option for the first region in the editing interface, wherein an initial size of the first region is a predetermined size; and
a selecting sub-unit, configured to display materials for selection in the first region.

In some embodiments, the displaying sub-unit is configured to: determine a track cursor in the editing interface in response to the trigger operation on the display option for the first region; and display a first region including the track cursor in the editing interface.

In some embodiments, the displaying sub-unit is configured to: acquire a first time point corresponding to the track cursor; acquire a second time point by advancing the first time point by a first duration; acquire a third time point by delaying the first time point by a second duration; and display a first region corresponding to a first time period in the editing interface, wherein the second time point is a start time point of the first time period, and the third time point is an end time point of the first time period.

In some embodiments, the displaying sub-unit is configured to: acquire any two coordinate points in the track cursor; acquire a plurality of coordinate points by translating each of the any two coordinate points leftwards and rightwards; and display the first region in the editing interface based on the plurality of coordinate points, wherein the plurality of coordinate points are vertexes of the first region.

In some embodiments, the displaying sub-unit is configured to: acquire a fourth time point and a fifth time point in response to the trigger operation on the display option for the first region, wherein the fourth time point is a start time point of the editing interface, and the fifth time point is an end time point of the editing interface; and display a first region corresponding to a second time period in the editing interface, wherein the second time period is a time period between the fourth time point and the fifth time point.

In some embodiments, the apparatus further includes:
an adjusting unit, configured to adjust the first region in response to an adjust operation on the first region, wherein the adjust operation is configured to adjust at least one of a position and a size of the first region.

In some embodiments, the selecting unit is further configured to: display a second region in the editing interface in response to a trigger operation on a display option for the second region in the editing interface, wherein the second region is configured to display materials for deselection; and deselect materials in the second region.

In some embodiments, the selecting unit is further configured to: deselect materials completely in the second region; or deselect materials at least partially in the second region.

In some embodiments, the selecting unit includes:
a display sub-unit, configured to displaying the first region in the editing interface according to a swipe path of a swipe operation in response to the swipe operation in the editing interface; and
a selecting sub-unit, configured to display materials for selection in the first region.

In some embodiments, the displaying sub-unit is configured to: display the first region according to a start point and a release point of the swipe path in response to the swipe operation, wherein the first region is a matrix with the start point and the release point being diagonal points, or a circle with a connecting line between the start point and the release point being a diameter; or display the first region formed by the swipe path in response to the swipe operation, wherein the first region is an enclosed region formed by the swipe path.

In some embodiments, the selecting unit is further configured to: select a plurality of materials completely in the first region; or select a plurality of materials at least partially in the first region.

In some embodiments, the selecting unit is further configured to display materials for selection completely in the first region in response to a trigger operation on a cover selection option in the editing interface; and
the selecting unit is further configured to display materials for selection at least partially in the first region in response to a trigger operation on a cross selection option in the editing interface.

In some embodiments, the selecting unit is further configured to select materials in a target track in response to a select operation on the target track in the at least one first track.

In some embodiments, the selecting unit is further configured to deselect any one of the selected plurality of materials in response to a deselect operation on the any one of the selected plurality of materials.

In some embodiments, the first track is a sub-track of a second track, and at least one second track is displayed in the editing interface; and the displaying unit is further configured to display the at least one first track of the second track in the editing interface in response to a trigger operation on any of the at least one second track, wherein the at least one material in the at least one first track belongs to a material type corresponding to the second track.

In some embodiments, the apparatus further includes:
a determining unit, configured to select history materials in response to a trigger operation on a history selection option in the editing interface, wherein the history materials include a plurality of materials selected at a previous time.

In some embodiments, the editing unit is configured to display an editing option available to the plurality of materials in the editing interface; and bulk-edit the selected plurality of materials in response to a trigger operation on any displayed editing option.

In yet another aspect of the embodiments of the present disclosure, a terminal is provided. The terminal includes:
a processor; and
a memory configured to store one or more instructions executable by the processor;
wherein the processor, when loading and executing the one or more instructions, is caused to:
display at least one first track in an editing interface, wherein each of the at least one first track includes at least one material;
select a plurality of materials in a first region in response to a set operation on the first region in the editing interface, wherein the first region is configured to display materials for selection; and
bulk-edit the selected plurality of materials.

In still yet another aspect of the embodiments of the present disclosure, a non-transitory computer readable storage medium is provided. Wherein one or more instructions stored in the computer readable storage medium, when loaded and executed by a processor of a terminal, cause the terminal to:
display at least one first track in an editing interface, wherein each of the at least one first track includes at least one material;
select a plurality of materials in a first region in response to a set operation on the first region in the editing interface, wherein the first region is configured to display materials for selection; and
bulk-edit the selected plurality of materials.

In still yet another aspect of the embodiments of the present disclosure, a computer program product including one or more computer programs is provided. Wherein the one or more computer programs when loaded and run by a processor, cause the processor to:
display at least one first track in an editing interface, wherein each of the at least one first track includes at least one material;
select a plurality of materials in a first region in response to a set operation on the first region in the editing interface, wherein the first region is configured to display materials for selection; and
bulk-edit the selected plurality of materials.

It should be understood that the above general descriptions and the following detailed description are merely exemplary and explanatory, which are not used to limit the present disclosure.

### BRIEF DESCRIPTION OF DRAWINGS

FIG. 1 a flowchart of a method for editing materials according to some embodiments of the present disclosure;

FIG. 2 is a schematic diagram of an editing interface according to some embodiments of the present disclosure;

FIG. 3 is a schematic diagram of an editing interface according to some embodiments of the present disclosure;

FIG. 4 is a flowchart of a method for editing materials according to some embodiments of the present disclosure;

FIG. 5 is a schematic diagram of displaying a first region according to some embodiments of the present disclosure;

FIG. 6 is a schematic diagram of displaying a first region according to some embodiments of the present disclosure;

FIG. 7 is a schematic diagram of adjusting a first region according to some embodiments of the present disclosure;

FIG. 8 is a schematic diagram of an editing interface according to some embodiments of the present disclosure;

FIG. 9 is a flowchart of a method for editing materials according to some embodiments of the present disclosure;

FIG. 10 is a flowchart of a method for editing materials according to some embodiments of the present disclosure;

FIG. 11 is a schematic diagram of an editing interface according to some embodiments of the present disclosure;

FIG. 12 is a schematic diagram of an editing interface according to some embodiments of the present disclosure;

FIG. 13 is a flowchart of a method for editing materials according to some embodiments of the present disclosure;

FIG. 14 is a schematic block diagram of an apparatus for editing materials according to some embodiments of the present disclosure;

FIG. 15 is a schematic block diagram of an apparatus for editing materials according to some embodiments of the present disclosure; and

FIG. 16 is a schematic block diagram of forming a terminal according to some embodiments of the present disclosure.

### DETAILED DESCRIPTION

For clearer understanding of the technical solutions of the present disclosure by those of ordinary skill in the art, the technical solutions of the embodiments of the present disclosure are clearly and completely described in conjunction with the accompanying drawings.

The information involved in the present disclosure is authorized by the user or sufficiently authorized by the parties.

To improve a playback effect of the video, a user can select and edit a material, and sequentially edit a plurality of materials to synthesize the video based on the plurality of edited materials. However, the above process requires a large amount of edit operations, resulting in a low editing efficiency and a long editing time.

The embodiments of the present disclosure provide a method for editing materials, and the method is performed by a terminal. In some embodiments, the terminal is a laptop, a mobile phone, a tablet personal computer, or other terminal.

The method for editing materials in the present disclosure is applicable to a scenario of editing videos. The application scenario of the embodiments of the present disclosure is described hereinafter.

Illustratively, the user adds a plurality of materials in a video editing tool. In the method for editing materials, the user bulk-selects a plurality of materials for bulk-editing, such that the user quickly edits the plurality of materials, and the efficiency of editing materials is improved. Then, the user synthesizes the video based on the plurality of edited materials by the video editing tool, and thus the efficiency of editing materials is further improved.

The method for editing materials in the embodiments of the present disclosure is also applicable to other scenarios, which is not limited in the embodiments of the present disclosure.

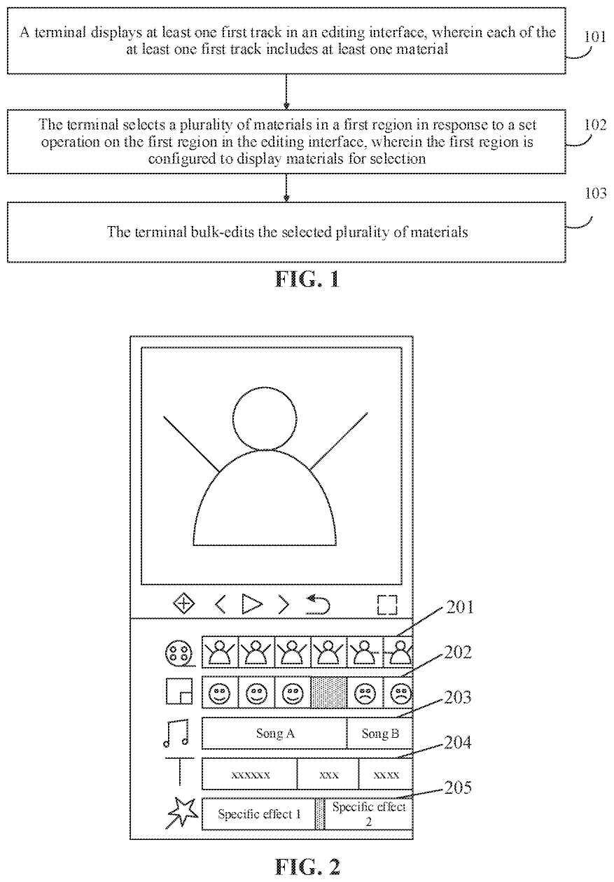

FIG. 1 a flowchart of a method for editing materials according to some embodiments of the present disclosure. As shown in FIG. 1, the method is performed by a terminal, and includes the following processes.

In S101, the terminal displays at least one first track in an editing interface, wherein each of the at least one first track includes at least one material.

In some embodiments, the editing interface is provided by a target application installed on the terminal, and the method for editing materials in the embodiments of the present disclosure is performed by the target application installed on the terminal.

The editing interface is an interface for editing materials. In some embodiments, the user adds materials in the editing interface. The material may be a video material, a picture-in-picture material, an audio material, a subtitle material, a specific effect material, and a material of any other type, and the types of the materials are not limited in the embodiments of the present disclosure. Upon adding the material in the editing interface, the user further edits the added material in the editing interface, for example, adjusts a playback speed of the material, adjusts playback volume of the material, deletes the material, segments the material, and the like, and the manner of editing the material is not limited in the embodiments of the present disclosure.

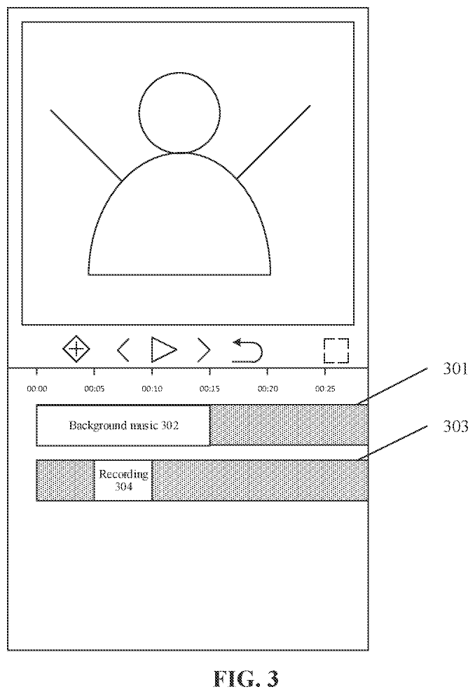

In some embodiments, each first track is a track for accommodating one type of materials. That is, one first track corresponds to one type of materials, and is configured to accommodate such type of materials. Illustratively, as shown in FIG. 2, the editing interface displays five first tracks, that is, a video track 201, a picture-in-picture track 202, an audio track 203, a subtitle track 204, and a specific effect track 205. The video track 201 is configured to accommodate video materials, the picture-in-picture track 202 is configured to accommodate picture-in-picture materials, the audio track 203 is configured to accommodate audio materials, the subtitle track 204 is configured to accommodate subtitle materials, and the specific effect track 205 is configured to accommodate specific effect materials.

In some embodiments, the at least one first track is configured to accommodate the same type of materials. In some embodiments, in the case that the user wants to add a plurality of materials of the same type and in the same time period, the user can create a plurality of first tracks, and the plurality of materials are disposed in the plurality of first tracks. In an example illustrated in FIG. 3, the user can create two first tracks, 301 and 303. The editing interface also displays a time line above the first tracts 301 and 303. In the example, the user wants to playback a background music from 0 second to 15^{th} second and playback a recording from fifth second to tenth second. As shown in FIG. 3, the user can create two first tracks, a background music material 302 is disposed from 0 second to 15^{th} second in the first track 301, and a recording material 304 is disposed from fifth second to tenth second in the first track 303. The background music material 302 and the recording material 304 are materials of audio type.

It should be noted that the first track and the material in the editing interface are disposed in the editing interface by the user, and the first track and the material are not limited in the embodiments of the present disclosure. In addition, the embodiments of the present disclosure are described only by taking the editing interface displaying the first track as an example, and the content displayed in the editing interface is not limited. In some embodiments, the editing interface may display other contents, for example, a region display option, and the like.

In S102, the terminal selects a plurality of materials in a first region in response to a set operation on the first region in the editing interface, wherein the first region is configured to display materials for selection.

The set operation on the first region is an operation that can be triggered or activated in the editing interface or a control and configured to set the first region. In some embodiments, the editing interface displays a region display option configured to display a first region with a predetermined size in the editing interface, and an operation of displaying the first region is a trigger operation on the region display option. In some embodiments, the first region is manually drawn by the user. Thus, the set operation on the first region is a swipe operation triggered by the user, and the position and the size of the first region are determined based on a swipe path of the swipe operation. The set operation is exemplarily described in the embodiments of the present disclosure, which is not limited in the embodiments of the present disclosure.

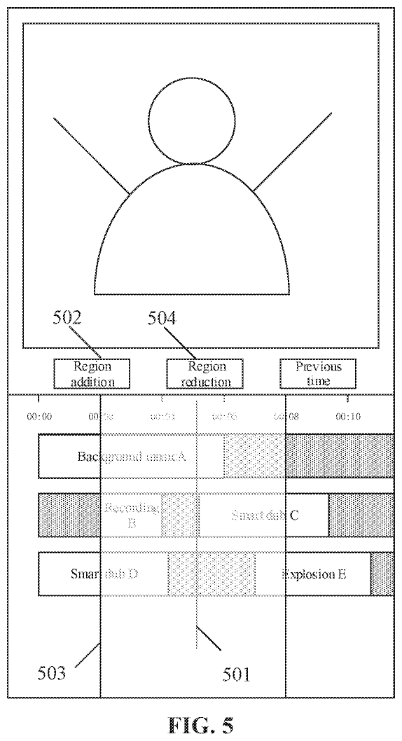

In some embodiments, the terminal displays the first region in the editing interface in response to the set operation on the first region in the editing interface, and selects the plurality of materials in the region. As shown in FIG. 2 and FIG. 3, the materials in the editing interface are disposed in different regions of the editing interface, and part of the materials will be in the first region upon display of the first region in the editing interface, and the first region is illustrated in FIG. 5 to FIG. 8 for example.

It should be noted that a number of the materials in the region is correlated with distribution of the materials in the first track, and thus the number of the materials in the region is not limited in the embodiments of the present disclosure. For example, in the case that the editing interface includes one material, the first region includes one material. For example, in the case that the editing interface includes a plurality of materials, the first region includes a plurality of materials.

The objective of the method for editing materials in the embodiments of the present disclosure is to bulk-select the plurality of materials and bulk-edit the selected plurality of materials when a user wants to edit a plurality of materials. Thus, the embodiments of the present disclosure are described by taking the first region including a plurality of materials as an example. In actual applications, the user can select one material by the first region, which is not limited in the embodiments of the present disclosure.

In S103, the terminal bulk-edits the selected plurality of materials.

By bulk-editing, user edits the plurality of materials by one edit operation. For example, the terminal selects the video material and the audio material, and performs a speed vary operation, such that the speed variation of the video material and the audio material is achieved.

In the method for editing materials in the embodiments of the present disclosure, the first region is disposed in the editing interface, the plurality of materials in the first region are bulk-selected, and the bulk-selected plurality of materials are bulk-edited, such that the user is not required to sequentially edit the plurality of materials, the operation of the user is reduced, and the efficiency of editing the materials is improved.

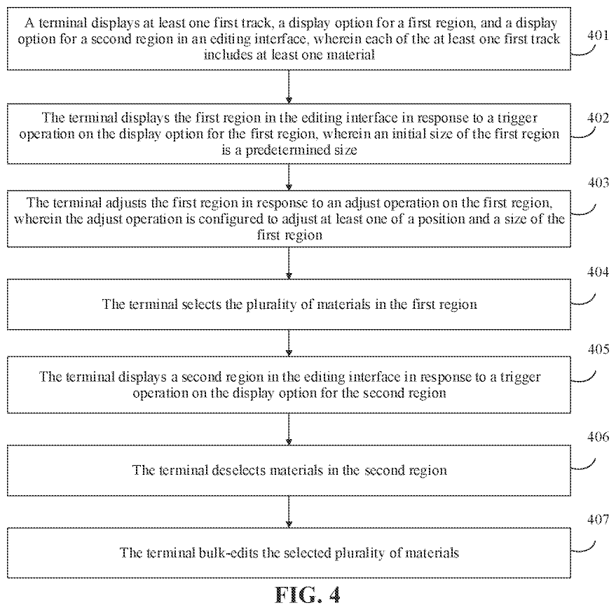

In the embodiments shown in FIG. 1, the terminal selects the plurality of materials in the first region in response to the set operation on the first region in the editing interface. In some embodiments, the editing interface further displays a region display option, the region display option is configured to display a first region with a first predetermined size in the editing interface, and the set operation on the first region is a trigger operation on the region display option. The embodiments of the present disclosure are described by taking the embodiments of the set operation on the first region being the trigger operation on the region display option shown in FIG. 4 as an example.

FIG. 4 is a flowchart of a method for editing materials according to some embodiments of the present disclosure. As shown in FIG. 4, the method is performed by a terminal, and includes the following processes.

In S401, the terminal displays at least one first track, a display option for the first region, and a display option for the second region in an editing interface, wherein each of the at least one first track includes at least one material.

S401 and S101 differ in that, in S401, the terminal displays the display option for the first region and the display option for the second region. The display option for the first region is configured to trigger display of the first region, and the first region is configured to display materials for selection. The display option for the second region is configured to trigger display of the second region, and the second region is configured to display materials for deselection. The display option for the first region and the display option for the second region are respectively illustrated by S402 and S405 in the embodiments of the present disclosure.

Other contents in S401 are similar to those of S101, which are not repeated.

In S402, the terminal displays the first region in the editing interface in response to a trigger operation on a display option for the first region, wherein an initial size of the first region is a predetermined size.

The display option for the first region is configured to trigger display of the first region, and the first region is configured to display materials for selection. In the case that the user performs a trigger operation on the display option for the first region, the terminal displays the first region in the editing interface, and the materials in the first region are selected.

The initial size of the first region is the predetermined size, and the predetermined size is any size, which is not limited in the embodiments of the present disclosure. A shape of the first region is in any shape, for example, a rectangle, a circle, and the like, which is not limited in the embodiments of the present disclosure.

In some embodiments, the terminal displaying the first region in the editing interface in response to the trigger operation on the display option for the first region includes: the terminal determining a track cursor in the editing interface in response to the trigger operation on the display option for the first region, and displaying a first region including the track cursor in the editing interface. The track cursor is configured to position a position in the first track, and the determined first regions are different based on different positions of the track cursor. For example, the position of the track cursor is a central position of the first region, and the like. The user controls the position of the first region by changing the position of the track cursor, and thus controls materials in the region, such that the random choice of materials is achieved.

In some embodiments, the first region is a region corresponding to a time period, and positions in the first track correspond to corresponding time periods. The terminal displaying the first region including the track cursor in the editing interface includes: acquiring a first time point corresponding to the track cursor; acquiring a second time point by advancing the first time point by a first duration (moving toward left relative to the track cursor); acquiring a third time point by delaying the first time point by a second duration (moving toward right relative to the track cursor); and displaying a first region corresponding to a first time period in the editing interface, wherein the second time point is a start time point of the first time period, and the third time point is an end time point of the first time period. The first duration and the second duration are durations that are predetermined or determined based on an operation of the user, and are equal or not equal, which are not limited in the embodiments of the present disclosure.

That is, upon determining the second time point and the third time point, the terminal determines the first time period with the second time point being a start time point and the third time point being an end time point, and determines the first region corresponding to the first time period in the editing interface. Times points corresponding to positions in the first region belong to time points in the first time period. That is, positions corresponding to the time points in the first time period form the first region. The first region is displayed with a boundary, and an area inside the boundary covers the materials for selection. The first region is configured to be recognizable or distinguishable from other displayed items such that it is easy and convenient for the user to select the materials. In some embodiments, the boundary of the first region is a line enclosing an area inside the first region, and the first track and the materials for selection behind the area are visible. In some embodiments, the area inside the boundary of the first region has shade or color different from the background color, and the first tracks and materials in the first region are visible. In some embodiments, the first region is adjustable by the user via changing the boundary or changing vertex of boundary.

In an embodiment shown in FIG. 5, the editing interface displays a track cursor 501 and a “region addition” option 502, a “region reduction” operation, and a “previous time” option. The editing interface further shows that the first time point corresponding to the track cursor 501 is and the first duration and the second duration are 3s. In response to a trigger operation on the “region addition” option 502, the terminal determines the second time point as 00:02 (that is, a 2^{nd} second) and the third time point as 00:08 (that is, an 8^{th} second), and thus a first region 503 corresponding to a time period from 00:02 to 00:08 is displayed in the editing interface. In some embodiments, the first region is displayed in response to the trigger operation on the display option for the first region, and the first regions are different based on different positions of the track cursor in the editing interface. In some embodiments, the first region is a region corresponding to a time period, and the first regions are different based on predetermined first durations and the second durations.

It should be noted that the embodiments of the present disclosure are described by taking the first region being determined based on the time point corresponding to the track cursor as an example. In some embodiments, the terminal determines the first region based on the time period corresponding to the editing interface. For example, the terminal displaying the first region in the editing interface in response to the trigger operation on the display option for the first region includes: acquiring a fourth time point and a fifth time point in response to the trigger operation on the display option for the first region, wherein the fourth time point is a start time point of the editing interface, and the fifth time point is an end time point of the editing interface; determining a second time period between the fourth time point and the fifth time point, and displaying a first region corresponding to the second time period in the editing interface.

The terminal determining the second time period between the fourth time point and the fifth time point includes: the terminal acquiring a sixth time point by delaying the fourth time point by a third duration (moving toward right relative to the track cursor), and acquiring a seventh time point by advancing the fifth time point (moving toward left relative to the track cursor) by a fourth duration. The sixth time point is determined as a start time point of the second time period, and the seventh time point is determined as an end time point of the second time period.

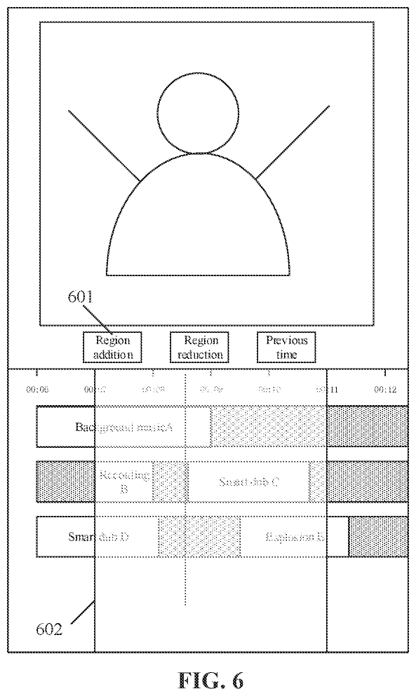

As shown in FIG. 6, a current start time point of the editing interface is 00:06, and an end time point of the editing interface is 00:12, and the terminal displays a first region 602 corresponding to a time period from 00:07 to 00:11 in the editing interface in response to a trigger operation on the “region addition” option 601 in the editing interface.

It should be noted that the processes of determining the first region are illustrated in the embodiments of the present disclosure by taking determination of a first region corresponding to a time point as an example. In some embodiments, the terminal displaying the first region in the editing interface in response to the trigger operation on the display option for the first region includes: the terminal acquiring a plurality of predetermined coordinate points in response to the trigger operation on the display option for the first region, and displaying the first region in the editing interface based on the plurality of coordinate points. The plurality of coordinate points are vertexes of the first region. In some embodiments, the terminal displaying the first region including the track cursor in the editing interface includes: the terminal acquiring any two coordinate points in the track cursor in response to the trigger operation on the display option for the first region, acquiring a plurality of coordinate points by translating each of the any two coordinate points leftwards and rightwards, and displaying the first region in the editing interface based on the plurality of coordinate points, wherein the plurality of coordinate points are vertexes of the first region. For example, four coordinate points are acquired by translating each coordinate point by a target distance leftwards and rightwards, and a region formed by the four coordinate points being vertexes is determined as a first region.

In S403, the terminal adjusts the first region in response to an adjust operation on the first region, wherein the adjust operation is configured to adjust at least one of a position and a size of the first region.

As the initial size of the first region is the predetermined size, the first region may not meet needs of the user. Thus, the user adjusts the first region, such that at least one of the position and the size of the first region is changed to meet the needs of the user.

The manner of adjusting the first region is illustrated hereinafter in the embodiments of the present disclosure.

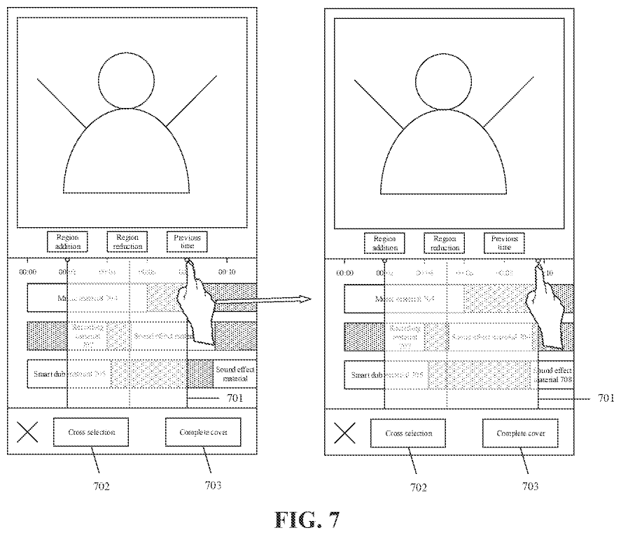

In some embodiments, the first region is a region corresponding to the first time period, and can be adjusted by the user. As shown in FIG. 7, the editing interface is configured such that the user can adjust at least one of the position and the size of the first region by moving a time cursor in the first region.

In some embodiments, upon the terminal displaying the first region in the editing interface, the user may press and move a boundary or a vertex of the first region to change the size of the first region, and press and move the first region to change the location of the first region on the editing interface.

In some embodiments, the editing interface displays a region adjustment option. In the example illustrated in FIG. 5, the region adjustment option is the “region addition” option 502 and the “region reduction” option 504. The “region addition” option 502 allows the user to increase the size of the first region, and the “region reduction” option 504 allows the user to reduce the size of the first region. In some embodiments, upon a trigger operation on “region addition”, the user can move a vertex of boundary or the first region to increase the size of the first region; and upon a trigger operation on “region reduction”, the user can move a vertex or boundary of the first region to decrease the size of the first region. In some embodiments, a trigger operation of the “region addition” option 502 enables an automatic increase of the first region to a preset size by just tapping the “region addition” option 502, and a trigger operation of the “region reduction” option 504 enables an automatic decrease of the first region to a preset size by just tapping the “region reduction” option 504. Thus, the user can adjust the first region by performing a trigger operation on the “region addition” option 502 and the “region reduction” option 504. It should be noted that the display option for the first region is the “region addition” option 502 or the “region reduction” option 504. Thus, the terminal displays the first region in the editing interface in the case that the user taps the “region addition” option 502 or the “region reduction” option 504, and the user again taps the “region addition” option 502 or the “region reduction” option 504 to increase or reduce the first region.

It should be noted that the manner of adjusting the first region is illustrated in the embodiments of the present disclosure by taking the first region requiring to be adjusted as an example, and thus S403 is performed or not performed according to actual needs in actual applications, which is not limited in the embodiments of the present disclosure.

In S404, the terminal selects the plurality of materials in the first region.

In some embodiments, the terminal selecting the plurality of materials in the first region includes: selecting a plurality of materials completely in the first region, or selecting a plurality of materials at least partially in the first region.

Whether the terminal selects the plurality of materials completely in the first region or the plurality of materials at least partially in the first region is predetermined by the user. In the case that the user predetermines that the terminal selects the plurality of materials completely in the first region, the terminal selects the plurality of materials completely in the first region each time the terminal displays the first region, unless the user changes the setting.

Considering that the needs of the user are different each time the terminal selects the materials in the first region, the user determines whether to select the plurality of materials completely in the first region or the plurality of materials at least partially in the first region based on the materials in the first region upon each display of the first region by the terminal for convenience and flexibility of selecting materials by the user.

In some embodiments, the editing interface further displays a cross selection option and a cover selection option, and the method further includes: upon display of the first region in the editing interface, selecting the plurality of materials completely in the first region in response to a trigger operation on the cover selection option; or, upon display of the first region in the editing interface, selecting the plurality of materials at least partially in the first region in response to a trigger operation on a cross selection option in the editing interface.

It should be noted that the cross selection option and the cover selection option are always displayed in the editing interface, or displayed upon display of the first region in the editing interface, and the cross selection option or the cover selection option disappears upon the trigger operation on the cross selection option or the cover selection option by the user.

As shown in FIG. 7, the terminal displays a “cross selection” option 702 (that is, the cross selection option) and a “complete cover” option 703 (that is, the cover selection option) upon displaying the first region 701 in the editing interface. Upon adjustment of the first region 701 and tapping of the “cross selection” option 702 by the user, the terminal selects a music material 704, a smart dub material 705, a sound effect material 706, a recording material 707, and a sound effect material 708 that are overlapped with the first region. Upon adjustment of the first region 701 and tapping of the “complete cover” option 703 by the user, the terminal selects a sound effect material 706 that is completely in the first region. That is, the “cross selection” option 702 can cause materials at least partially in the first region to be selected, and the “complete cover” option 703 can only cause materials completely in the first region to be selected.

In some embodiments, the terminal distinguishingly displays selected materials and unselected materials for clear understanding of the selected materials and the unselected materials. In some embodiments, the selected materials are marked. For example, a frame is added for the selected materials, a selection mark is added for the selected materials, and the like.

In some embodiments, for convenience of management of the selected materials, the terminal adds material marks of the selected materials to a multiple-selections set.

In S405, the terminal displays a second region in the editing interface in response to a trigger operation on a display option for the second region.

The second region is configured to display materials for deselection. The user performs the trigger operation on the display option for the second region, the terminal displays the second region in the editing interface, and thus the materials in the second region are deselected.

In some embodiments, an initial size of the second region is a predetermined size, and the predetermined size is any size, which is not limited in the embodiments of the present disclosure. A shape of the second region is in any shape, for example, a rectangle, a circle, and the like, which is not limited in the embodiments of the present disclosure.

In some embodiments, the “region addition” option 502 in FIG. 5 is the display option for the first region, and the “region reduction” option 504 in FIG. 5 is the display option for the second region.

The manner of displaying the second region in the editing interface is similar as the manner of displaying the first region in the editing interface, which are not repeated herein.

In S406, the terminal deselects materials in the second region.

In some embodiments, the terminal deselecting materials in the second region includes: deselecting materials completely in the second region, or deselecting materials at least partially in the second region.

Whether the terminal deselects the materials completely in the second region or the materials at least partially in the second region may be predetermined by the user. In the case that the user determines that the terminal deselects the materials completely in the second region, the terminal deselects the materials completely in the second region each time the terminal displays the second region, unless the user changes the setting.

Considering that the needs of the user are different each time the terminal deselects the materials in the second region, the user determines whether to deselect the materials completely in the second region or the materials at least partially in the second region based on the materials in the second region upon each display of the second region by the terminal for convenience and flexibility of deselecting the materials by the user.

In some embodiments, the editing interface further displays a cross selection option and a cover selection option, and the method further includes: upon display of the second region in the editing interface, deselecting the materials completely in the second region in response to a trigger operation on the cover selection option; or, upon display of the second region in the editing interface, deselecting the materials at least partially in the second region in response to a trigger operation on a cross selection option in the editing interface.

It should be noted that the cross selection option and the cover selection option are always displayed in the editing interface, or displayed upon display of the first region in the editing interface, and the cross selection option or the cover selection option disappears upon the trigger operation on the cross selection option or the cover selection option by the user.

In some embodiments, for convenience of management of the selected materials, the terminal adds material marks of the selected materials to a multiple-selections set. In the case that a material is deselected, a material mark of the material is deleted from the multiple-selections set.

It should be noted that the embodiments of the present disclosure are described by taking deselecting the materials in the second region as an example, and whether to deselect materials or which material is to be deselected is determined according to actual needs. That is, whether to perform S405 and S406 is determined according to actual needs in actual applications.

In some embodiments, the user deselects materials in other ways. For example, the terminal deselects the materials in response to the deselect operation on the any one of the selected materials. The deselect operation is a tap operation on the selected materials, and the deselect operation is not limited in the embodiments of the present disclosure.

In S407, the terminal bulk-edits the selected plurality of materials.

The terminal provides different editing options for different types of materials to achieve diversified editing of the different types of materials. In the embodiments of the present disclosure, the user selects a plurality of materials and bulk-edits the plurality of materials. The terminal only displays an editing option available to the selected plurality of materials in the editing interface to address a failure to bulk-edit the material.

In some embodiments, the terminal bulk-editing the selected materials includes: displaying the editing option available to the plurality of materials in the editing interface, and bulk-editing the selected plurality of materials in response to a trigger operation on any displayed editing option.

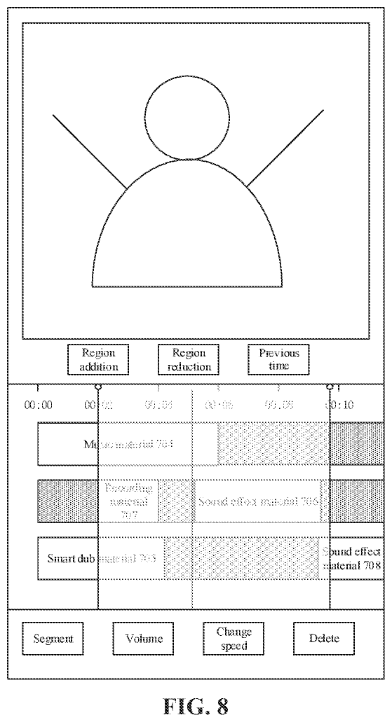

In some embodiments, as shown in FIG. 8, a plurality of editing options are displayed below the plurality of materials, and the plurality of editing options are updated with the change of the selected materials. The editing options displayed in FIG. 8 includes “Segment”, “Volume”, “Change Speed”, and “Delete.”

It should be noted that the embodiments of the present disclosure are described by taking display of the editing option available to the selected materials as an example. In some embodiments, the editing interface displays all editing options, and editing options not available to the selected materials are display in gray, such that the user cannot perform the edit operation through such editing options.

In some embodiments, the method for editing materials to synthesize a video includes: displaying a plurality of first tracks and a time line in an editing interface, wherein each first track comprises at least one material; selecting a plurality of materials in a first region in response to a set operation on the first region in the editing interface, wherein the first region is configured to display materials for selection and an area of the first region covers the materials for selection, and corresponds to a time period indicated by the time line, and wherein the set operation is a control activable by a user; and bulk-editing the selected plurality of materials, wherein the bulk-editing is performed on the selected materials simultaneously upon a trigger operation on an editing option by the user.

In the method for editing materials in the embodiments of the present disclosure, the first region is displayed in the editing interface based on the trigger operation on the display option for the first region, and the first region includes a plurality of materials to be edited, and the plurality of materials in the first region are selected, such that the operation of the user for selecting the plurality of materials is greatly simplified. Upon selection of the materials in the first region, the selected materials are bulk-operated, such that the operation of the user is further simplified, and the efficiency of editing the materials of the user is improved.

In addition, the first region is configured to be adjustable to change at least one of the position and the size, such that the first region includes the materials desired to be edited by the user, and the method for bulk-selecting the materials is more flexible.

In addition, the second region is displayed in the editing interface based on the trigger operation on the display option for the second region, and the materials in the second region are deselected, such that the user can bulk-deselect materials, and the selection of the materials is more flexible.

In addition, the cross selection option and the cover selection option are displayed each time the first region is displayed, such that the user determines whether to select the materials completely in the first region or the materials at least partially in the first region based on the current needs of the user, and the flexibility of selecting the materials is further improved.

In addition, upon selection of the plurality of materials by the user, the terminal displays the editing option available to the plurality of materials in the editing interface, such that a failure to bulk-edit the selected plurality of materials based on the editing option is addressed, and the editing experience of the user is improved.

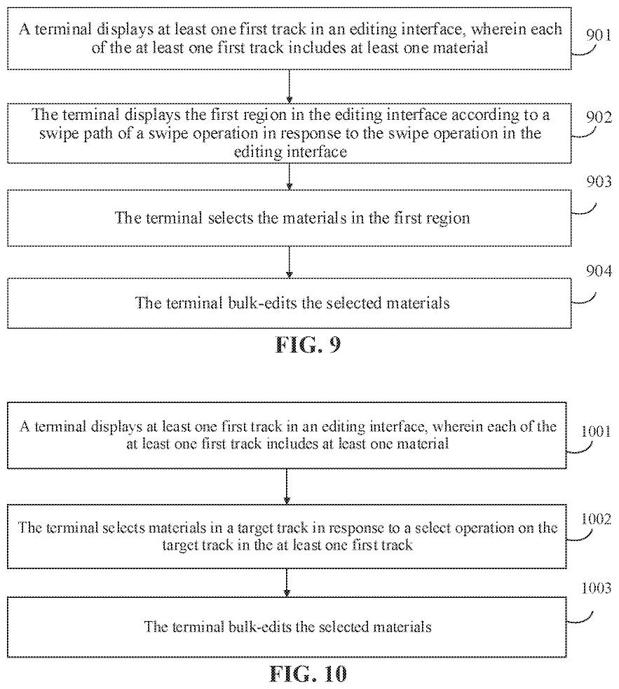

In the embodiments shown in FIG. 1, the terminal selects the plurality of materials in the first region in response to the set operation on the first region in the editing interface. In some embodiments, the first region is manually drawn, and thus the set operation on the first region is a swipe operation triggered by the user. The embodiments of the present disclosure are described by taking the embodiments of “the set operation on the first region being the swipe operation triggered by the user” shown in FIG. 9 as an example.

FIG. 9 is a flowchart of a method for editing materials according to some embodiments of the present disclosure. As shown in FIG. 9, the method is performed by the terminal, and includes the following processes.

In S901, the terminal displays at least one first track in an editing interface, wherein each of the at least one first track includes at least one material.

S901 is similar to S101, which is not repeated herein.

In S902, the terminal displays the first region in the editing interface according to a swipe path of a swipe operation in response to the swipe operation in the editing interface.

In some embodiments, the shape of the first region is a predetermined shape, for example, a rectangle, a circle, and the like, which is not limited in the embodiments of the present disclosure.

Taking the shape of the first region being the rectangle as an example, the terminal determines a start point and a release point of the swipe operation, and the start point and the release point are determined as two diagonal points of the rectangle to display the first region. That is, the terminal displays the first region according to a start point and a release point of the swipe path in response to the swipe operation. The first region is a matrix with the start point and the release point being diagonal points.

Taking the shape of the first region being the circle as an example, the terminal determines a start point and a release point of the swipe operation, and the start point and the release point are determined as a diameter of the circle to display the first region. That is, the terminal displays the first region according to a start point and a release point of the swipe path in response to the swipe operation. The first region is a circle with a connecting line between the start point and the release point being a diameter.

In some embodiments, the shape of the first region is an irregular shape. The first region is an enclosed region formed by the swipe path of the swipe operation. The terminal determines the swipe path of the swipe operation as a boundary of the first region. That is, the terminal displays the first region formed by the swipe path in response to the swipe operation. The first region is an enclosed region formed by the swipe path.

In S903, the terminal selects the materials in the first region.

S903 is similar to S404, which is not repeated herein.

In S904, the terminal bulk-edits the selected materials.

S904 is similar to S107, which is not repeated herein.

In the method for editing materials in the embodiments of the present disclosure, the user performs the swipe operation in the editing interface, the terminal displays the first region in the editing interface according to the swipe path of a swipe operation and selects the materials in the first region, such that the operation of selecting the plurality of materials by the user is simplified, and the user selects the materials more flexibly.

It should be noted that in the embodiments of the present disclosure, the plurality of materials are bulk-selected based on the operation of displaying the first region or in other manners. For example, the materials are bulk-selected by selecting a track. The embodiments of the present disclosure are described by taking the embodiments of “bulk-selecting the materials by selecting the track” shown in FIG. 10 as an example.

FIG. 10 is a flowchart of a method for editing materials according to some embodiments of the present disclosure. As shown in FIG. 10, the method is performed by the terminal, and includes the following processes.

In S1001, the terminal displays at least one first track in an editing interface, wherein each of the at least one first track includes at least one material.

S1001 is similar to S101, which is not repeated herein.

In S1002, the terminal selects materials in a target track in response to a select operation on the target track in the at least one first track.

In some embodiments, the select operation on the target track is any trigger operation on the target track. In some embodiments, the editing interface displays a check box corresponding to each first track, and the user achieves the select operation on the target track by selecting the check box corresponding to the target track.

In some embodiments, each first track is a track for accommodating one type of materials. Selecting the first track refers to selection of the materials of the corresponding type. For example, selecting the video material refers to selection of each video material. Selecting the picture-in-picture material refers to selection of each picture-in-picture material.

In some embodiments, the at least one first track is configured to accommodate a plurality of secondary-type of materials, and the plurality of secondary-type of materials belong to the same primary-type. For example, the at least one first track is configured to accommodate a plurality of secondary-type of materials, such as a music material, a recording material, a smart dub material, a sound effect material, and the like. The music material, the recording material, the smart dub material, and the sound effect material belong to the same primary-type, that is, an audio material. Thus, in the case that the at least one first track is configured to accommodate a plurality of secondary-type of materials, and the plurality of secondary-type of materials belong to the same primary-type, the user selects a first track, and the materials in the first track are selected even if the materials in the first track belong to different secondary-types.

In some embodiments, the first track is a sub-track of a second track, and at least one second track is displayed in the editing interface. Displaying at least one first track in the editing interface includes: displaying the at least one first track of the second track in the editing interface in response to a trigger operation on any of the at least one second track. The materials in the at least one first track belong to a material type corresponding to the second track.

In some embodiments, the material type corresponding to the second track is the primary-type, the first track includes materials of at least one secondary-type, and the at least one secondary-type is the sub-track of the primary track.

Illustratively, the editing interface displays a second track, that is, an audio track, the user taps the audio track, and the terminal displays three sub-tracks of the audio track in the editing interface. The first track is disposed with a music material, the second sub-track is disposed with a smart dub material and a sound effect material, and the third track is disposed with a recording material.

It should be noted that in the method for editing materials in the embodiments of the present disclosure, the materials can be selected, and the material can be deselected. In some embodiments, the method for editing materials further includes: the terminal deselecting materials in a first track in response to a deselect operation on any selected first track. In some embodiments, the method further includes: the terminal deselecting any one of the selected plurality of materials in response to a deselect operation on the any one of the selected plurality of materials.

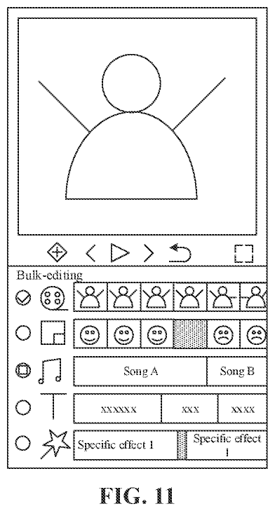

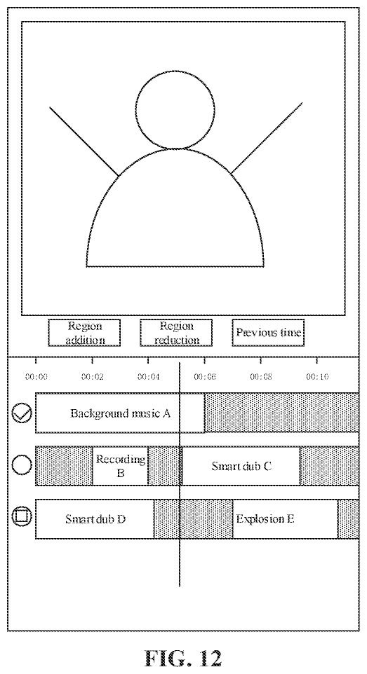

It should be further noted that in the case that the editing interface displays the check box corresponding to each first track, the terminal displays selection of materials in the first track of the check box based on the check box. Illustratively, as shown in FIG. 11 and FIG. 12, in the case that a check box displays a check mark, materials in the first track of the check box are all selected; in the case that a check box displays a block, materials in the first track of the check box are partially selected; and in the case that a check box displays nothing, materials in the first track of the check box are not selected.

In S1003, the terminal bulk-edits the selected materials.

S1003 is similar to S407, which is not repeated herein.

In the method for editing materials in the embodiments of the present disclosure, materials in a track are selected by selecting the track, and the selected materials are bulk-edited, such that the user is not required to separately edit the plurality of materials, the operation of the user is reduced, and the efficiency of editing the materials is improved.

It should be noted that in the embodiments of the present disclosure, the plurality of materials are bulk-selected based on the operation of displaying the first region or in other manners.

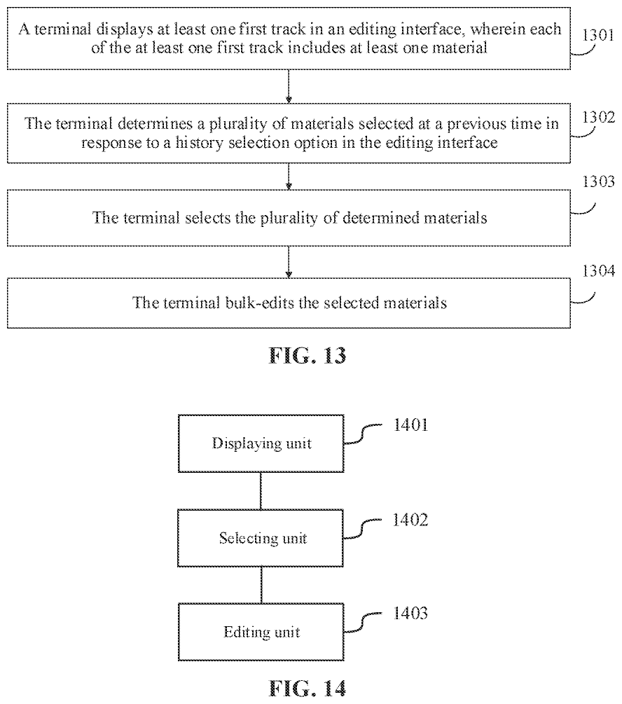

For example, the materials are bulk-selected by selecting history materials. The embodiments of the present disclosure are described by taking the embodiments of “bulk-selecting the materials by selecting the history material” shown in FIG. 13 as an example.

FIG. 13 is a flowchart of a method for editing materials according to some embodiments of the present disclosure. As shown in FIG. 13, the method is performed by the terminal, and includes the following processes.

In S1301, the terminal displays at least one first track in an editing interface, wherein each of the at least one first track includes at least one material.

S1301 is similar to S101, which is not repeated herein.

In S1302, the terminal determines a plurality of materials selected at a previous time in response to a history selection option in the editing interface.

The editing interface further displays the history selection option, and the history selection option is configured to bulk-select the plurality of materials selected at the previous time in bulk. In some embodiments, the history selection option is a “previous time” option in FIG. 12.

The plurality of materials selected at the previous time may be selected by any one or a plurality of methods of bulk-selecting materials in the embodiments of the present disclosure by the user, which is not limited in the embodiments of the present disclosure.

For example, upon selection of the plurality of materials and bulk-editing of the plurality of materials by the user, the terminal stores material marks of the plurality of materials, and acquires the material marks of the plurality of materials in response to the trigger operation on the history selection option in the editing interface.

In S1303, the terminal selects the plurality of determined materials.

In some embodiments, the terminal selecting the plurality of determined materials includes: the terminal selecting materials corresponding to the material marks based on the acquired material marks.

That is, the terminal selects history materials in response to a trigger operation on a history selection option in the editing interface, and the history materials include a plurality of materials selected at a previous time.

In S1304, the terminal bulk-edits the selected materials.

S1304 is similar to S407, which is not repeated herein.

In the method for editing materials in the embodiments of the present disclosure, upon selection of the plurality of materials and bulk-editing of the plurality of materials, the plurality of materials selected at the previous time are edited in one time by the history selection option, and the plurality of materials are edited again, such that the efficiency of editing the materials is improved.

It should be noted that the embodiments shown in FIG. 4, FIG. 9, FIG. 11, and FIG. 13 are randomly combined. That is, the user may bulk-select materials in the terminal using any or a combination of the embodiments shown in FIG. 4, FIG. 9, FIG. 11, and FIG. 13.

For example, the editing interface displays a video track, a picture-in-picture track, an audio track, a subtitle track, and a specific effect track. In the case that the user selects the picture-in-picture track, the terminal selects the materials in the picture-in-picture track. In the case that the user taps the audio track, and three sub-tracks of the audio track are displayed in the editing interface, the user selects the first sub-track, the first region is displayed in the editing interface based on the region display option, and partial materials between the second sub-track and the third sub-track are selected through the first region. Then, the user taps the unselected materials, such that the unselected materials are selected. The user taps the selected materials, such that the materials are deselected. The selected plurality of materials are adjusted by a tap operation on the materials by the user, and the user bulk-edits the selected plurality of materials upon adjustments.

Then, the terminal stores material marks of the selected plurality of materials, and selects the plurality of materials selected at the previous time based on the stored material marks in the case that the user taps the history selection option.

In some embodiments, the terminal displays a bulk option in the editing interface, and the terminal performs the embodiments shown in FIG. 1, FIG. 4, FIG. 9, FIG. 11, and FIG. 13 in the case that the user selects the bulk option.

FIG. 14 is a schematic block diagram of an apparatus for editing materials according to some embodiments of the present disclosure. Referring to FIG. 14, the apparatus includes:
a displaying unit 1401, configured to display at least one first track in an editing interface, wherein each of the at least one first track includes at least one material;
a selecting unit 1402, configured to select a plurality of materials in a first region in response to a set operation on the first region in the editing interface, wherein the first region is configured to display materials for selection; and
an editing unit 1403, configured to bulk-edit the selected plurality of materials.

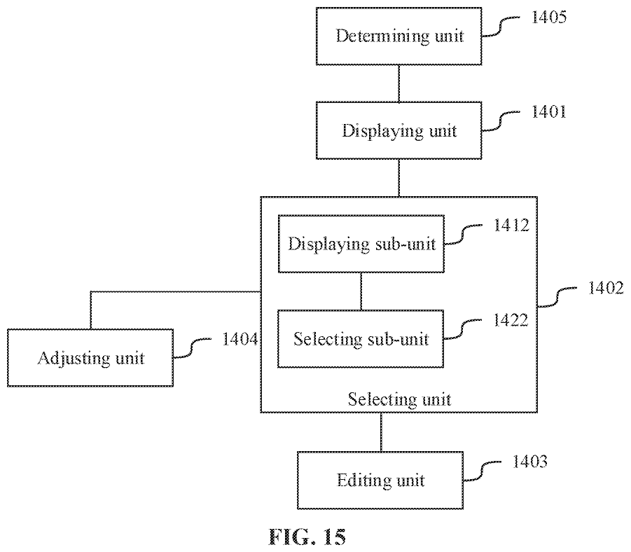

As shown in FIG. 15, in some embodiments, the selecting unit 1402 includes:
a displaying sub-unit 1412, configured to display the first region in the editing interface in response to a trigger operation on a display option for the first region in the editing interface, wherein an initial size of the first region is a predetermined size; and
a selecting sub-unit 1422, configured to display materials for selection in the first region.

In some embodiments, the displaying sub-unit 1412 is configured to: determine a track cursor in the editing interface in response to the trigger operation on the display option for the first region; and
display a first region including the track cursor in the editing interface.

In some embodiments, the displaying sub-unit 1412 is configured to: acquire a first time point corresponding to the track cursor; acquire a second time point by advancing the first time point by a first duration; acquire a third time point by delaying the first time point by a second duration; and display a first region corresponding to a first time period in the editing interface, wherein the second time point is a start time point of the first time period, and the third time point is an end time point of the first time period.

In some embodiments, the displaying sub-unit 1412 is configured to: acquire any two coordinate points in the track cursor; acquire a plurality of coordinate points by translating each of the any two coordinate points leftwards and rightwards; and display the first region in the editing interface based on the plurality of coordinate points, wherein the plurality of coordinate points are vertexes of the first region.

In some embodiments, the displaying sub-unit 1412 is configured to: acquire a fourth time point and a fifth time point in response to the trigger operation on the display option for the first region, wherein the fourth time point is a start time point of the editing interface, and the fifth time point is an end time point of the editing interface; and display a first region corresponding to a second time period in the editing interface, wherein the second time period is a time period between the fourth time point and the fifth time point.

In some embodiments, the apparatus further includes:
an adjusting unit 1404, configured to adjust the first region in response to an adjust operation on the first region, wherein the adjust operation is configured to adjust at least one of a position and a size of the first region.

In some embodiments, the selecting unit 1402 is further configured to: display a second region in the editing interface in response to a trigger operation on a display option for the second region in the editing interface; and deselect materials in the second region.

In some embodiments, the selecting unit 1402 is further configured to: deselect materials completely in the second region; or deselect materials at least partially in the second region.

In some embodiments, the selecting unit 1402 includes:
a display sub-unit 1412, configured to displaying the first region in the editing interface according to a swipe path of a swipe operation in response to the swipe operation in the editing interface; and
a selecting sub-unit 1422, configured to display materials for selection in the first region.

In some embodiments, the displaying sub-unit 1412 is configured to: display the first region according to a start point and a release point of the swipe path in response to the swipe operation, wherein the first region is a matrix with the start point and the release point being diagonal points, or a circle with a connecting line between the start point and the release point being a diameter; or display the first region formed by the swipe path in response to the swipe operation, wherein the first region is an enclosed region formed by the swipe path.

In some embodiments, the selecting unit 1402 is further configured to: select a plurality of materials completely in the first region; or select a plurality of materials at least partially in the first region.

In some embodiments, the selecting unit 1402 is further configured to display materials for selection completely in the first region in response to a trigger operation on a cover selection option in the editing interface; and
the selecting unit 1402 is further configured to display materials for selection at least partially in the first region in response to a trigger operation on a cross selection option in the editing interface.

In some embodiments, the selecting unit 1402 is further configured to select materials in a target track in response to a select operation on the target track in the at least one first track.

In some embodiments, the selecting unit 1402 is further configured to deselect any one of the selected plurality of materials in response to a deselect operation on the any one of the selected plurality of materials.

In some embodiments, the first track is a sub-track of a second track, and at least one second track is displayed in the editing interface; and the displaying unit 1401 is further configured to display the at least one first track of the second track in the editing interface in response to a trigger operation on any of the at least one second track, wherein the at least one material in the at least one first track belongs to a material type corresponding to the second track.

In some embodiments, the apparatus further includes:
a determining unit 1405, configured to select history materials in response to a trigger operation on a history selection option in the editing interface, wherein the history materials include a plurality of materials selected at a previous time.

In some embodiments, the editing unit 1403 is configured to display an editing option available to the plurality of materials in the editing interface; and bulk-edit the selected plurality of materials in response to a trigger operation on any displayed editing option.

Specific manners of performing the operations of the units in the apparatus for editing materials in the above embodiments are described in the corresponding method embodiments, which are not repeated herein.

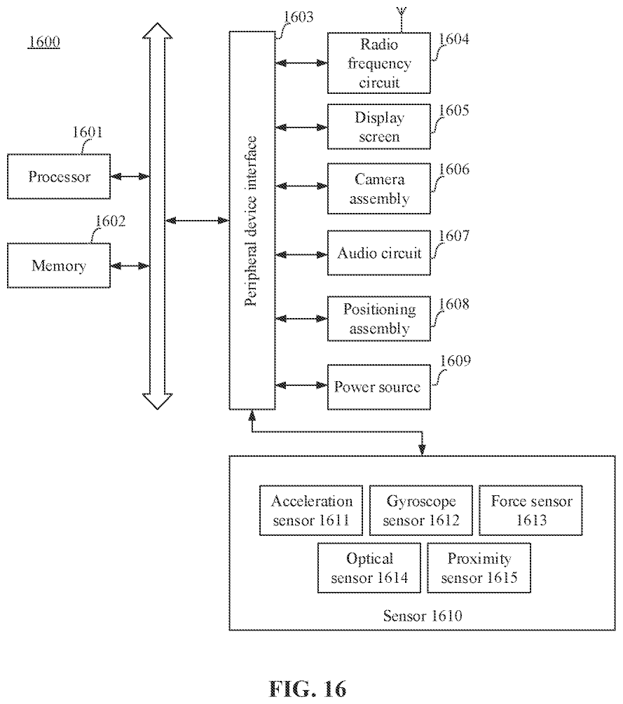

FIG. 16 is a schematic block diagram of forming a terminal according to some embodiments of the present disclosure. In some embodiments, the terminal 1600 may be a desktop computer, a laptop computer, a tablet computer, a smart mobile phone, or other terminals. The terminal 1600 may also be referred to as a user equipment, a portable terminal, a laptop terminal, a desktop terminal, or the like.

Generally, the terminal 1600 may include a processor 1601 and a memory 1602.

In some embodiments, the processor 1601 includes one or more processing cores, for example, a four-core processor, an eight-core processor, or the like. In some embodiments, the processor 1601 is implemented by at least one hardware of a digital signal processor (DSP), a field-programmable gate array (FPGA), and a programmable logic array (PLA). In some embodiments, the processor 1601 further includes a primary processor and a secondary processor. The primary processor is a processor configured to process data in an active state, and is also referred to as a central processing unit (CPU). The secondary processor is a low-power consumption processor configured to process data in a standby state. In some embodiments, the processor 1601 is integrated with a graphics processing unit (GPU), and the GPU is configured to render and draw the content to be displayed on the display screen. In some embodiments, the processor 1601 further includes an Artificial Intelligence (AI) processor configured to perform calculation operations related to machine learning.

In some embodiments, the memory 1602 includes one or more computer-readable storage media, and the computer-readable storage medium is non-transitory. In some embodiments, the memory 1602 further includes a high-speed random-access memory, and a non-volatile memory, for example, one or more magnetic disk storage devices or flash storage devices. In some embodiments, the non-transitory computer-readable storage medium in the memory 1602 is configured to store executable instructions. The executable instructions, when loaded and executed by the processor 1601, cause the processor 1601 to perform the method for editing materials according to the embodiments of the present disclosure.

In some embodiments, the terminal 1600 includes a peripheral device interface 1603 and at least one peripheral device. In some embodiments, the processor 1601, the memory 1602, and the peripheral device interface 1603 are connected to each other via a bus or a signal line. In some embodiments, the peripheral device is connected to the peripheral device interface 1603 via a bus, a signal line, or a circuit board. Specifically, the peripheral device includes at least one of a radio frequency circuit 1604, a display screen 1605, a camera assembly 1606, an audio circuit 1607, a positioning assembly 1608, and a power source 1609.

The peripheral device interface 1603 is configured to connect the at least one peripheral device related to input/output (I/O) to the processor 1601 and the memory 1602. In some embodiments, the processor 1601, the memory 1602, and the peripheral device interface 1603 are integrated on the same chip or circuit board. In some embodiments, any one or two of the processor 1601, the memory 1602, and the peripheral device interface 1603 are achieved on a separate chip or circuit board, which is not limited in the embodiments of the present disclosure.

The radio frequency circuit 1604 is configured to receive and transmit a radio frequency (RF) signal, which is also referred to as an electromagnetic signal. The radio frequency circuit 1604 is communicated with a communication network or another communication device via the electromagnetic signal. The radio frequency circuit 1604 converts an electrical signal to an electromagnetic signal and sends the signal, or converts a received electromagnetic signal to an electrical signal. In some embodiments, the radio frequency circuit 1604 includes: an antenna system, an RF transceiver, one or a plurality of amplifiers, a tuner, an oscillator, a digital signal processor, a codec chip set, a user identification module card, or the like. In some embodiments, the radio frequency circuit 1604 is communicated with another terminal based on at least one wireless communication protocol. The wireless communication protocol includes, but is not limited to: a world wide web, a metropolitan area network, an intranet, various generations of mobile communication networks (2G, 3G, 4G and 5G), a wireless local area network and/or a wireless fidelity (Wi-Fi) network. In some embodiments, the radio frequency circuit 1604 further includes a near-field communication (NFC)-related circuits, which is not limited in the present disclosure.

The display screen 1605 is configured to display a user interface (UI). In some embodiments, the UE includes graphics, texts, icons, videos, and any combination thereof. In the case that the display screen 1605 is a touch display screen, the display screen 1605 further has the capability of acquiring a touch signal on or above the surface of the display screen 1605. In some embodiments, the touch signal is input to the processor 1601 as a control signal for processing. In this case, the display screen 1605 is further configured to provide a virtual button and/or a virtual keyboard or keypad, which is also referred to as a soft button and/or a soft keyboard or keypad. In some embodiments, one display screen 1605 is provided, which is disposed on a front panel of the terminal 1600. In some embodiments, at least two display screens 1605 are provided, which are respectively disposed on different surfaces of the terminal 1600 or designed in a folded fashion. In some other embodiments, the display screen 1605 is a flexible display screen disposed on a bent surface or a folded surface of the terminal 1600. Even, the display screen 1605 is further disposed as an irregular pattern other than a rectangular, that is, a specially-shaped screen. In some embodiments, the display screen 1605 is fabricated from such materials as a liquid crystal display (LCD), an organic light-emitting diode (OLED), or the like.

The camera assembly 1606 is configured to capture an image or a video. In some embodiments, the camera assembly 1606 includes a front camera and/or a rear camera. Generally, the front camera is disposed on a front panel of the terminal, and the rear camera is disposed on a rear panel of the terminal. In some embodiments, at least two rear cameras are disposed, which are any one of a primary camera, a depth of field (DOF) camera, a wide-angle camera, and a long-focus camera, such that the primary camera and the DOF camera are fused to achieve the background virtualization function, and the primary camera and the wide-angle camera are fused to implement the panorama photographing and virtual reality (VR) photographing functions or other fused photographing functions. In some embodiments, the camera assembly 1606 further includes a flash. In some embodiments, the flash is a single-color temperature flash or a double-color temperature flash. The double-color temperature flash refers to a combination of a warm-light flash and a cold-light flash, which is used for light compensation under different color temperatures.

The audio circuit 1607 includes a microphone and a speaker. The microphone is configured to capture an acoustic wave of a user and an environment, and convert the acoustic wave to an electrical signal and output the electrical signal to the processor 1601 for further processing, or output to the radio frequency circuit 1604 to achieve voice communication. For the purpose of stereo capture or noise reduction, a plurality of such microphones are provided, which are disposed at different positions of the terminal 1600. In some embodiments, the microphone is a microphone array or an omnidirectional capturing microphone. The speaker is configured to convert an electrical signal from the processor 1601 or the radio frequency circuit 1604 to an acoustic wave. In some embodiments, the speaker is a traditional thin-film speaker, or a piezoelectric ceramic speaker. In the case that the speaker is a piezoelectric ceramic speaker, an electrical signal is converted to an acoustic wave audible by human beings, or an acoustic wave inaudible by human beings for the purpose of ranging or the like. In some embodiments, the audio circuit 1607 further includes a headphone plug.

The positioning assembly 1608 is configured to position a geographic position of the terminal 1600 to achieve navigation or location based services (LBS).

The power source 1609 is configured to supply power for various assemblies in the terminal 1600. In some embodiments, the power source 1609 is an alternating current, a direct current, a disposable battery, or a rechargeable battery. In the case that the power source 1609 includes a rechargeable battery, the rechargeable battery is a wired charging battery or a wireless charging battery. The wired charging battery is a battery charged in a wired line, and the wireless charging battery is a battery changed in a wireless coil. The rechargeable battery also supports the supercharging technology.

In some embodiments, the terminal 1600 further includes one or more sensors 1610. The one or more sensors 1610 include, but are not limited to: an acceleration sensor 1611, a gyroscope sensor 1612, a force sensor 1613, an optical sensor 1614, and a proximity sensor 1615.

In some embodiments, the acceleration sensor 1611 is configured to detect accelerations on three coordinate axes in a coordinate system established for the terminal 1600. For example, the acceleration sensor 1611 is configured to detect components of a gravity acceleration on the three coordinate axes. In some embodiments, the processor 1601 controls the display screen 1605 to display the user interface in a horizontal view or a longitudinal view based on a gravity acceleration signal acquired by the acceleration sensor 1611. In some embodiments, the acceleration sensor 1611 is further configured to acquire motion data of a game or a user.

In some embodiments, the gyroscope sensor 1612 is configured to detect a body direction and a rotation angle of the terminal 1600, and the gyroscope sensor 1612 is collaborated with the acceleration sensor 1611 to capture a 3D action performed by the user for the terminal 1600. Based on the data acquired by the gyroscope sensor 1612, the processor 1601 achieves the following functions: action sensing (for example, modifying the UI based on an inclination operation of the user), image stabilization in photographing, game control, and inertial navigation.

In some embodiments, the force sensor 1613 is disposed on a side frame of the terminal 1600 and/or on a lowermost layer of the display screen 1605. In the case that the force sensor 1613 is disposed on the side frame of the terminal 1600, a grip signal of the user against the terminal 1600 is detected, and the processor 1601 performs a left or right hand identification or performs a shortcut operation based on the grip signal acquired by the force sensor 1613. In the case that the force sensor 1613 is disposed on the lowermost layer of the display screen 1605, the processor 1601 achieves control of an operable control on the UI based on a force operation of the user against the display screen 1605. The operable control includes at least one of a button control, a scroll bar control, an icon control, and a menu control.

The optical sensor 1614 is configured to acquire the intensity of ambient light. In one embodiment, the processor 1601 controls a display luminance of the display screen 1605 based on the intensity of ambient light acquired by the optical sensor 1614. Specifically, in the case that the intensity of ambient light is high, the display luminance of the display screen 1605 is up-shifted; and in the case that the intensity of ambient light is low, the display luminance of the display screen 1605 is down-shifted. In some embodiments, the processor 1601 further dynamically adjusts photographing parameters of the camera assembly 1606 based on the intensity of ambient light acquired by the optical sensor 1614.

The proximity sensor 1615, also referred to as a distance sensor, is generally disposed on the front panel of the terminal 1600. The proximity sensor 1615 is configured to acquire a distance between the user and the front face of the terminal 1600. In some embodiments, in the case that the proximity sensor 1615 detects that the distance between the user and the front face of the terminal 1600 gradually decreases, the processor 1601 controls the display screen 1605 to switch from an active state to a rest state; and in the case that the proximity sensor 1615 detects that the distance between the user and the front face of the terminal 1600 gradually increases, the processor 1601 controls the display screen 1605 to switch from the rest state to the active state.

A person skilled in the art may understand that the structure as illustrated in FIG. 16 does not construe a limitation on the terminal 1600. The terminal 1600 may include more or fewer assemblies over those illustrated in FIG. 8, or combinations of some components, or employ different component deployments.

In some embodiments, a terminal is further provided. The terminal includes: a processor, and a memory for storing one or more instructions executable by the processor. The processor, when executing the one or more instructions, is caused to:
display at least one first track in an editing interface, wherein each of the at least one first track includes at least one material;
select a plurality of materials in a first region in response to a set operation on the first region in the editing interface, wherein the first region is configured to display materials for selection; and
bulk-edit the selected plurality of materials.

In some embodiments, the processor, when executing the one or more instructions, is caused to: display the first region in the editing interface in response to a trigger operation on a display option for the first region in the editing interface, wherein an initial size of the first region is a predetermined size; and select the plurality of materials in the first region.

In some embodiments, the processor, when executing the one or more instructions, is caused to: determine a track cursor in the editing interface in response to the trigger operation on the display option for the first region; and display a first region including the track cursor in the editing interface.

In some embodiments, the processor, when executing the one or more instructions, is caused to: acquire a first time point corresponding to the track cursor; acquire a second time point by advancing the first time point by a first duration; acquire a third time point by delaying the first time point by a second duration; and display a first region corresponding to a first time period in the editing interface, wherein the second time point is a start time point of the first time period, and the third time point is an end time point of the first time period.

In some embodiments, the processor, when executing the one or more instructions, is caused to: acquire any two coordinate points in the track cursor; acquire a plurality of coordinate points by translating each of the any two coordinate points leftwards and rightwards; and display the first region in the editing interface based on the plurality of coordinate points, wherein the plurality of coordinate points are vertexes of the first region.

In some embodiments, the processor, when executing the one or more instructions, is caused to: acquire a fourth time point and a fifth time point in response to the trigger operation on the display option for the first region, wherein the fourth time point is a start time point of the editing interface, and the fifth time point is an end time point of the editing interface; and display a first region corresponding to a second time period in the editing interface, wherein the second time period is a time period between the fourth time point and the fifth time point.

In some embodiments, the processor, when executing the one or more instructions, is caused to: adjust the first region in response to an adjust operation on the first region, wherein the adjust operation is configured to adjust at least one of a position and a size of the first region.

In some embodiments, the processor, when executing the one or more instructions, is caused to: display a second region in the editing interface in response to a trigger operation on a display option for the second region in the editing interface, wherein the second region is configured to display materials for deselection; and deselect materials in the second region.

In some embodiments, the processor, when executing the one or more instructions, is caused to: deselect materials completely in the second region; or deselect materials at least partially in the second region.

In some embodiments, the processor, when executing the one or more instructions, is caused to: display the first region in the editing interface according to a swipe path of a swipe operation in response to the swipe operation in the editing interface; and select the plurality of materials in the first region.

In some embodiments, the processor, when executing the one or more instructions, is caused to: display the first region according to a start point and a release point of the swipe path in response to the swipe operation, wherein the first region is a matrix with the start point and the release point being diagonal points, or a circle with a connecting line between the start point and the release point being a diameter; or display the first region formed by the swipe path in response to the swipe operation, wherein the first region is an enclosed region formed by the swipe path.

In some embodiments, the processor, when executing the one or more instructions, is caused to: select a plurality of materials completely in the first region; or select a plurality of materials at least partially in the first region.

In some embodiments, the processor, when executing the one or more instructions, is caused to: select the plurality of materials completely in the first region in response to a trigger operation on a cover selection option in the editing interface; and select the plurality of materials at least partially in the first region in response to a trigger operation on a cross selection option in the editing interface.

In some embodiments, the processor, when executing the one or more instructions, is caused to: select materials in a target track in response to a select operation on the target track in the at least one first track.

In some embodiments, the processor, when executing the one or more instructions, is caused to: deselect any one of the selected plurality of materials in response to a deselect operation on the any one of the selected plurality of materials.

In some embodiments, the first track is a sub-track of a second track, and at least one second track is displayed in the editing interface. The processor, when executing the one or more instructions, is caused to: display the at least one first track of the second track in the editing interface in response to a trigger operation on any of the at least one second track, wherein the at least one material in the at least one first track belongs to a material type corresponding to the second track.

In some embodiments, the processor, when executing the one or more instructions, is caused to: select history materials in response to a trigger operation on a history selection option in the editing interface, wherein the history materials include a plurality of materials selected at a previous time.

In some embodiments, the processor, when executing the one or more instructions, is caused to: display an editing option available to the plurality of materials in the editing interface; and bulk-edit the selected plurality of materials in response to a trigger operation on any displayed editing option.

Some embodiments of the present disclosure further provide a computer-readable storage medium storing instructions, for example, a memory including one or more instructions. The one or more instructions, when loaded and executed by a processor of a terminal, cause the processor to perform the method for editing materials according to the above embodiments. In some embodiments, the computer-readable storage medium is a read-only memory (ROM), a random-access memory (RAM), a compact disc ROM (CD-ROM), a magnetic tape, a floppy disk, an optical data storage device, or the like.

In some embodiments, a computer-readable storage medium is further provided. The one or more instructions in the computer-readable storage medium, when loaded and executed by the processor of the terminal, cause the terminal to:
display at least one first track in an editing interface, wherein each of the at least one first track includes at least one material;
select a plurality of materials in a first region in response to a set operation on the first region in the editing interface, wherein the first region is configured to display materials for selection; and
bulk-edit the selected plurality of materials.

In some embodiments, the one or more instructions in the computer-readable storage medium, when loaded and executed by the processor of the terminal, cause the terminal to: display the first region in the editing interface in response to a trigger operation on a display option for the first region in the editing interface, wherein an initial size of the first region is a predetermined size; and select the plurality of materials in the first region.

In some embodiments, the one or more instructions in the computer-readable storage medium, when loaded and executed by the processor of the terminal, cause the terminal to: determine a track cursor in the editing interface in response to the trigger operation on the display option for the first region; and display a first region including the track cursor in the editing interface.

In some embodiments, the one or more instructions in the computer-readable storage medium, when loaded and executed by the processor of the terminal, cause the terminal to: acquire a first time point corresponding to the track cursor; acquire a second time point by advancing the first time point by a first duration; acquire a third time point by delaying the first time point by a second duration; and display a first region corresponding to a first time period in the editing interface, wherein the second time point is a start time point of the first time period, and the third time point is an end time point of the first time period.

In some embodiments, the one or more instructions in the computer-readable storage medium, when loaded and executed by the processor of the terminal, cause the terminal to: acquire any two coordinate points in the track cursor; acquire a plurality of coordinate points by translating each of the any two coordinate points leftwards and rightwards; and display the first region in the editing interface based on the plurality of coordinate points, wherein the plurality of coordinate points are vertexes of the first region.

In some embodiments, the one or more instructions in the computer-readable storage medium, when loaded and executed by the processor of the terminal, cause the terminal to: acquire a fourth time point and a fifth time point in response to the trigger operation on the display option for the first region, wherein the fourth time point is a start time point of the editing interface, and the fifth time point is an end time point of the editing interface; and display a first region corresponding to a second time period in the editing interface, wherein the second time period is a time period between the fourth time point and the fifth time point.

In some embodiments, the one or more instructions in the computer-readable storage medium, when loaded and executed by the processor of the terminal, cause the terminal to: adjust the first region in response to an adjust operation on the first region, wherein the adjust operation is configured to adjust at least one of a position and a size of the first region.

In some embodiments, the one or more instructions in the computer-readable storage medium, when loaded and executed by the processor of the terminal, cause the terminal to: display a second region in the editing interface in response to a trigger operation on a display option for the second region in the editing interface, wherein the second region is configured to display materials for deselection; and deselect materials in the second region.

In some embodiments, the one or more instructions in the computer-readable storage medium, when loaded and executed by the processor of the terminal, cause the terminal to: deselect materials completely in the second region; or deselect materials at least partially in the second region.

In some embodiments, the one or more instructions in the computer-readable storage medium, when loaded and executed by the processor of the terminal, cause the terminal to: display the first region in the editing interface according to a swipe path of a swipe operation in response to the swipe operation in the editing interface; and select the plurality of materials in the first region.

In some embodiments, the one or more instructions in the computer-readable storage medium, when loaded and executed by the processor of the terminal, cause the terminal to: display the first region according to a start point and a release point of the swipe path in response to the swipe operation, wherein the first region is a matrix with the start point and the release point being diagonal points, or a circle with a connecting line between the start point and the release point being a diameter; or display the first region formed by the swipe path in response to the swipe operation, wherein the first region is an enclosed region formed by the swipe path.

In some embodiments, the one or more instructions in the computer-readable storage medium, when loaded and executed by the processor of the terminal, cause the terminal to: select a plurality of materials completely in the first region; or select a plurality of materials at least partially in the first region.

In some embodiments, the one or more instructions in the computer-readable storage medium, when loaded and executed by the processor of the terminal, cause the terminal to: select the plurality of materials completely in the first region in response to a trigger operation on a cover selection option in the editing interface; and select the plurality of materials at least partially in the first region in response to a trigger operation on a cross selection option in the editing interface.

In some embodiments, the one or more instructions in the computer-readable storage medium, when loaded and executed by the processor of the terminal, cause the terminal to: select materials in a target track in response to a select operation on the target track in the at least one first track.

In some embodiments, the one or more instructions in the computer-readable storage medium, when loaded and executed by the processor of the terminal, cause the terminal to: deselect any one of the selected plurality of materials in response to a deselect operation on the any one of the selected plurality of materials.

In some embodiments, the first track is a sub-track of a second track, and at least one second track is displayed in the editing interface. The one or more instructions in the computer-readable storage medium, when loaded and executed by the processor of the terminal, cause the terminal to: display the at least one first track of the second track in the editing interface in response to a trigger operation on any of the at least one second track, wherein the at least one material in the at least one first track belongs to a material type corresponding to the second track.

In some embodiments, the one or more instructions in the computer-readable storage medium, when loaded and executed by the processor of the terminal, cause the terminal to: select history materials in response to a trigger operation on a history selection option in the editing interface, wherein the history materials include a plurality of materials selected at a previous time.

In some embodiments, the one or more instructions in the computer-readable storage medium, when loaded and executed by the processor of the terminal, cause the terminal to: display an editing option available to the plurality of materials in the editing interface; and bulk-edit the selected plurality of materials in response to a trigger operation on any displayed editing option.

Some embodiments of the present disclosure further provide a computer program product including one or more computer programs. The one or more computer programs, when laded and run by a processor, cause the processor to:
display at least one first track in an editing interface, wherein each of the at least one first track includes at least one material;
select a plurality of materials in a first region in response to a set operation on the first region in the editing interface, wherein the first region is configured to display materials for selection; and
bulk-edit the selected plurality of materials.

In some embodiments, the one or more computer programs, when loaded and run by a processor, cause the processor to: display the first region in the editing interface in response to a trigger operation on a display option for the first region in the editing interface, wherein an initial size of the first region is a predetermined size; and select the plurality of materials in the first region.

In some embodiments, the one or more computer programs, when loaded and run by a processor, cause the processor to: determine a track cursor in the editing interface in response to the trigger operation on the display option for the first region; and display a first region including the track cursor in the editing interface.

In some embodiments, the one or more computer programs, when loaded and run by a processor, cause the processor to: acquire a first time point corresponding to the track cursor; acquire a second time point by advancing the first time point by a first duration; acquire a third time point by delaying the first time point by a second duration; and display a first region corresponding to a first time period in the editing interface, wherein the second time point is a start time point of the first time period, and the third time point is an end time point of the first time period.

In some embodiments, the one or more computer programs, when loaded and run by a processor, cause the processor to: acquire any two coordinate points in the track cursor; acquire a plurality of coordinate points by translating each of the any two coordinate points leftwards and rightwards; and display the first region in the editing interface based on the plurality of coordinate points, wherein the plurality of coordinate points are vertexes of the first region.

In some embodiments, the one or more computer programs, when loaded and run by a processor, cause the processor to: acquire a fourth time point and a fifth time point in response to the trigger operation on the display option for the first region, wherein the fourth time point is a start time point of the editing interface, and the fifth time point is an end time point of the editing interface; and display a first region corresponding to a second time period in the editing interface, wherein the second time period is a time period between the fourth time point and the fifth time point.

In some embodiments, the one or more computer programs, when loaded and run by a processor, cause the processor to: adjust the first region in response to an adjust operation on the first region, wherein the adjust operation is configured to adjust at least one of a position and a size of the first region.

In some embodiments, the one or more computer programs, when loaded and run by a processor, cause the processor to: display a second region in the editing interface in response to a trigger operation on a display option for the second region in the editing interface, wherein the second region is configured to display materials for deselection; and deselect materials in the second region.

In some embodiments, the one or more computer programs, when loaded and run by a processor, cause the processor to: deselect materials completely in the second region; or deselect materials at least partially in the second region.

In some embodiments, the one or more computer programs, when loaded and run by a processor, cause the processor to: display the first region in the editing interface according to a swipe path of a swipe operation in response to the swipe operation in the editing interface; and select the plurality of materials in the first region.

In some embodiments, the one or more computer programs, when loaded and run by a processor, cause the processor to: display the first region according to a start point and a release point of the swipe path in response to the swipe operation, wherein the first region is a matrix with the start point and the release point being diagonal points, or a circle with a connecting line between the start point and the release point being a diameter; or display the first region formed by the swipe path in response to the swipe operation, wherein the first region is an enclosed region formed by the swipe path.

In some embodiments, the one or more computer programs, when loaded and run by a processor, cause the processor to: select a plurality of materials completely in the first region; or select a plurality of materials at least partially in the first region.

In some embodiments, the one or more computer programs, when loaded and run by a processor, cause the processor to: select the plurality of materials completely in the first region in response to a trigger operation on a cover selection option in the editing interface; and select the plurality of materials at least partially in the first region in response to a trigger operation on a cross selection option in the editing interface.

In some embodiments, the one or more computer programs, when loaded and run by a processor, cause the processor to: select materials in a target track in response to a select operation on the target track in the at least one first track.

In some embodiments, the one or more computer programs, when loaded and run by a processor, cause the processor to: deselect any one of the selected plurality of materials in response to a deselect operation on the any one of the selected plurality of materials.

In some embodiments, the first track is a sub-track of a second track, and at least one second track is displayed in the editing interface. The one or more computer programs, when loaded and run by a processor, cause the processor to: display the at least one first track of the second track in the editing interface in response to a trigger operation on any of the at least one second track, wherein the at least one material in the at least one first track belongs to a material type corresponding to the second track.

In some embodiments, the one or more computer programs, when loaded and run by a processor, cause the processor to: select history materials in response to a trigger operation on a history selection option in the editing interface, wherein the history materials include a plurality of materials selected at a previous time.

In some embodiments, the one or more computer programs, when loaded and run by a processor, cause the processor to: display an editing option available to the plurality of materials in the editing interface; and bulk-edit the selected plurality of materials in response to a trigger operation on any displayed editing option.

In some embodiments, the one or more computer programs involved in the embodiments of the present disclosure are deployed on an electronic device for execution, or are loaded and run by multiple electronic devices at the same location, or are loaded and run by multiple electronic devices at the multiple locations and interconnected over a communication network. The electronic devices at the multiple locations and interconnected over a communication network can form a block-chain system. The electronic device can be provided as a terminal.

All the embodiments of the present disclosure may be independently practiced, or practiced in combination with other embodiments, which are all considered as falling within the protection scope of the present disclosure.

1. A method for editing materials to synthesize a video on a terminal, comprising:
displaying at least one first track in an editing interface, wherein each of the at least one first track comprises at least one material;
selecting a plurality of materials in a first region in response to a set operation on the first region in the editing interface, wherein the first region is configured to display materials for selection; and
bulk-editing the selected plurality of materials.

2. The method according to claim 1, wherein selecting the plurality of materials in the first region in response to the set operation on the first region in the editing interface comprises:
displaying the first region in the editing interface in response to a trigger operation on a display option for the first region in the editing interface, wherein an initial size of the first region is a predetermined size; and
selecting the plurality of materials in the first region.

3. The method according to claim 2, wherein displaying the first region in the editing interface in response to the trigger operation on the display option for the first region in the editing interface comprises:
determining a track cursor in the editing interface in response to the trigger operation on the display option for the first region; and
displaying a first region comprising the track cursor in the editing interface, wherein the first region is displayed with a boundary, an area inside the boundary covers the material for selection, and the at least one first track and the material for selection behind the area are visible, and wherein the first region corresponds to a time period shown in the editing interface.

4. The method according to claim 3, wherein displaying the first region comprising the track cursor in the editing interface comprises:
acquiring a first time point corresponding to the track cursor;
acquiring a second time point by advancing the first time point by a first duration;
acquiring a third time point by delaying the first time point by a second duration; and
displaying a first region corresponding to a first time period in the editing interface, wherein the second time point is a start time point of the first time period, and the third time point is an end time point of the first time period.

5. The method according to claim 3, wherein displaying the first region comprising the track cursor in the editing interface comprises:
acquiring any two coordinate points in the track cursor;
acquiring a plurality of coordinate points by translating each of the any two coordinate points leftwards and rightwards; and
displaying the first region in the editing interface based on the plurality of coordinate points, wherein the plurality of coordinate points are vertexes of the first region.

6. The method according to claim 2, wherein displaying the first region in the editing interface in response to the trigger operation on the display option for the first region in the editing interface comprises:
acquiring a fourth time point and a fifth time point in response to the trigger operation on the display option for the first region, wherein the fourth time point is a start time point of the editing interface, and the fifth time point is an end time point of the editing interface; and
displaying a first region corresponding to a second time period in the editing interface, wherein the second time period is a time period between the fourth time point and the fifth time point.

7. The method according to claim 2, further comprising:
adjusting the first region in response to an adjust operation on the first region, wherein the adjust operation is configured to adjust at least one of a position and a size of the first region.

8. The method according to claim 2, further comprising:
displaying a second region in the editing interface in response to a trigger operation on a display option for the second region in the editing interface, wherein the second region is configured to display materials for deselection; and
deselecting materials in the second region.

9. The method according to claim 8, wherein deselecting the materials in the second region comprises:
deselecting materials completely in the second region; or
deselecting materials at least partially in the second region.

10. The method according to claim 1, wherein selecting the plurality of materials in the first region in response to the set operation on the first region in the editing interface comprises:
displaying the first region in the editing interface according to a swipe path of a swipe operation in response to the swipe operation in the editing interface; and
selecting the plurality of materials in the first region.

11. The method according to claim 10, wherein displaying the first region in the editing interface according to the swipe path of the swipe operation in response to the swipe operation in the editing interface comprises:
displaying the first region according to a start point and a release point of the swipe path in response to the swipe operation, wherein the first region is a matrix with the start point and the release point being diagonal points, or a circle with a connecting line between the start point and the release point being a diameter; or
displaying the first region formed by the swipe path in response to the swipe operation, wherein the first region is an enclosed region formed by the swipe path.

12. The method according to claim 1, wherein selecting the plurality of materials in the first region comprises:
selecting a plurality of materials completely in the first region; or
selecting a plurality of materials at least partially in the first region.

13. The method according to claim 11, wherein selecting the plurality of materials completely in the first region comprises:
selecting the plurality of materials completely in the first region in response to a trigger operation on a cover selection option in the editing interface; and
selecting the plurality of materials at least partially in the first region comprises:
selecting the plurality of materials at least partially in the first region in response to a trigger operation on a cross selection option in the editing interface.

14. The method according to claim 1, further comprising:
selecting materials in a target track in response to a select operation on the target track in the at least one first track.

15. The method according to claim 1, further comprising:
deselecting any one of the selected plurality of materials in response to a deselect operation on the any one of the selected plurality of materials.

16. The method according to claim 1, wherein
the first track is a sub-track of a second track, and at least one second track is displayed in the editing interface; and
displaying at least one first track in the editing interface comprises:
displaying the at least one first track of the second track in the editing interface in response to a trigger operation on any of the at least one second track, wherein the at least one material in the at least one first track belongs to a material type corresponding to the second track.

17. The method according to claim 1, further comprising:
selecting history materials in response to a trigger operation on a history selection option in the editing interface, wherein the history materials comprise a plurality of materials selected at a previous time.

18. The method according to claim 1, wherein said bulk-editing the selected plurality of materials comprises:
displaying an editing option available to the plurality of materials in the editing interface; and
bulk-editing the selected plurality of materials in response to a trigger operation on any displayed editing option.

19. A terminal, comprising:
a processor; and
a memory configured to store one or more instructions executable by the processor;
wherein the processor, when loading and executing the one or more instructions, is caused to:
display at least one first track in an editing interface, wherein each of the at least one first track comprises at least one material;
select a plurality of materials in a first region in response to a set operation on the first region in the editing interface, wherein the first region is configured to display materials for selection; and
bulk-edit the selected plurality of materials.

20. A non-transitory computer readable storage medium storing one or more instructions therein, wherein one or more instructions, when loaded and executed by a processor of a terminal, cause the terminal to:
display at least one first track in an editing interface, wherein each of the at least one first track comprises at least one material;
select a plurality of materials in a first region in response to a set operation on the first region in the editing interface, wherein the first region is configured to display materials for selection; and
bulk-edit the selected plurality of materials.
